(19) United States
(12) Patent Application Publication
(10) Pub. No.: US 2013/0311146 A1
(43) Pub. Date: Nov. 21, 2013

(54) DESIGN AND AUTHORIZATION SYSTEM FOR WIRELESS CONTROL

(71) Applicants: Ronald J. Miller, Beavercreek, OH (US); James Good, Centerville, OH (US)

(72) Inventors: Ronald J. Miller, Beavercreek, OH (US); James Good, Centerville, OH (US)

(73) Assignee: INTERACTIVE CONTROL SOLUTIONS, LLC, Beavercreek, OH (US)

(21) Appl. No.: 13/981,449

(22) PCT Filed: Jan. 25, 2012
(86) PCT No.: PCT/US12/22478

§ 371 Date: Jul. 24, 2013

Related U.S. Application Data
(60) Provisional application No. 61/437,317, filed on Jan. 28, 2011.

(51) Int. Cl. G06F 17/50

(52) U.S. Cl. CPC G06F 17/5004
USPC 703/1

(57) ABSTRACT

A system for designing, configuring, and reconfiguring operational relationships between one or more wireless control modifies within a controlled environment that are linked to pieces of utilization equipment or to an alternate electrical source, and one or more wireless control devices within a controlled environment. The system comprises application software and a database which interfaces with computer-aided design (CAD) software and with energy management systems.

A system for designing, configuring, and reconfiguring operational relationships between one or more Wireless Control Modules within a Controlled Environment that are linked to pieces of Utilization Equipment or to an Alternate Electrical Source, and one or more Wireless Control Devices within a Controlled Environment. The design and authorization system for wireless control is in essence a software product comprising application software and a database which interfaces with industry standard Computer-Aided Design (CAD) Software products and with Energy Management Systems.

These and additional features provided by the embodiments described herein will be more fully understood in view of the following detailed description, in conjunction with the drawings.

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

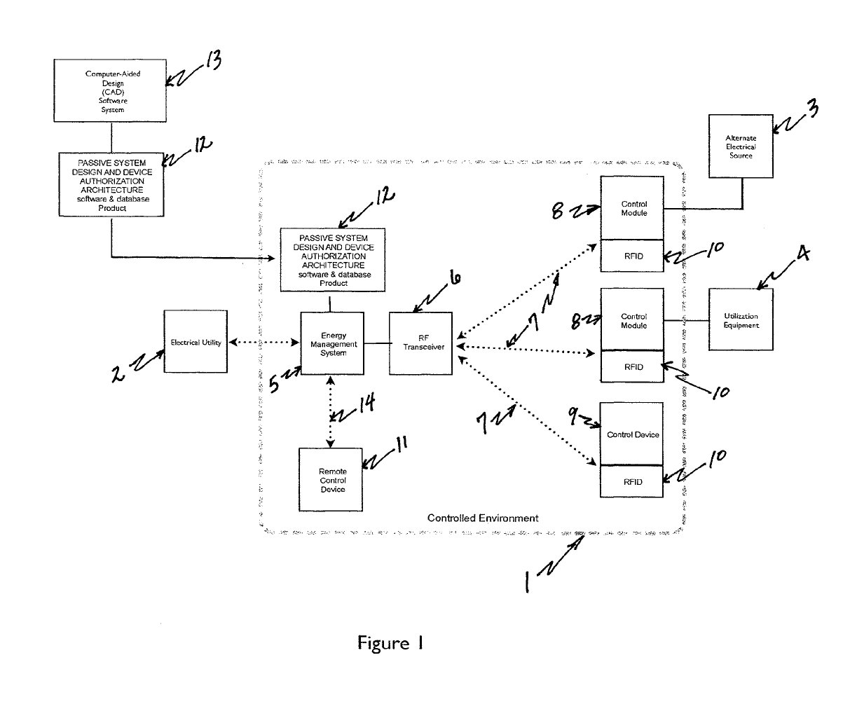

FIG. 1 depicts a system for designing, configuring, and reconfiguring operational relationships between one or more wireless control modules within a controlled environment according to one or more embodiments shown and described herein;

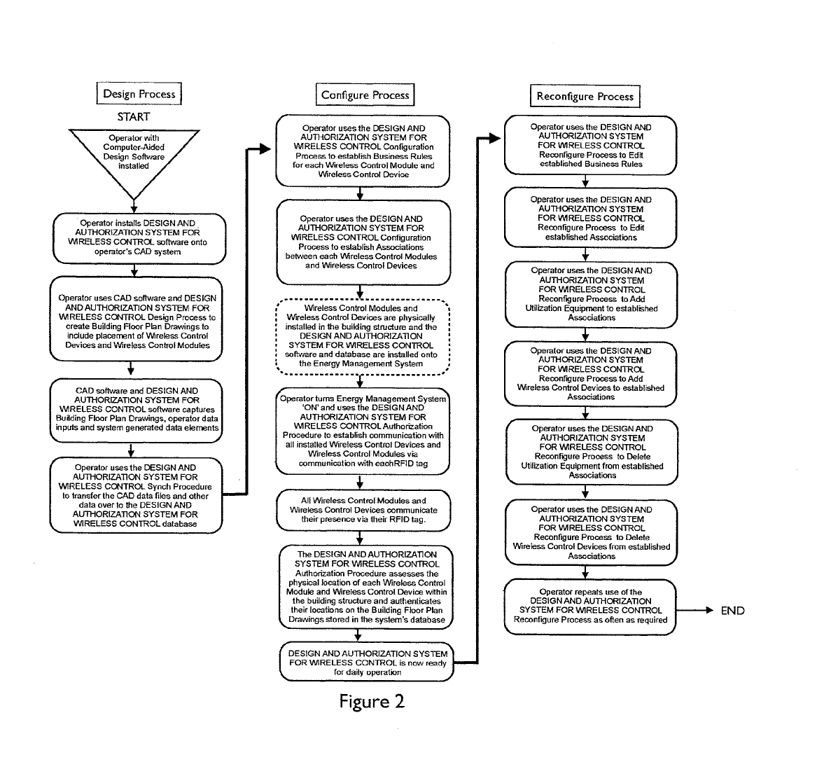

FIG. 2 depicts the various process steps followed for designing, configuring and reconfiguring operational relationships between one or more wireless control modules and one or more wireless control devices and/or virtual control devices within a controlled environment according to one or more embodiments shown and described herein;

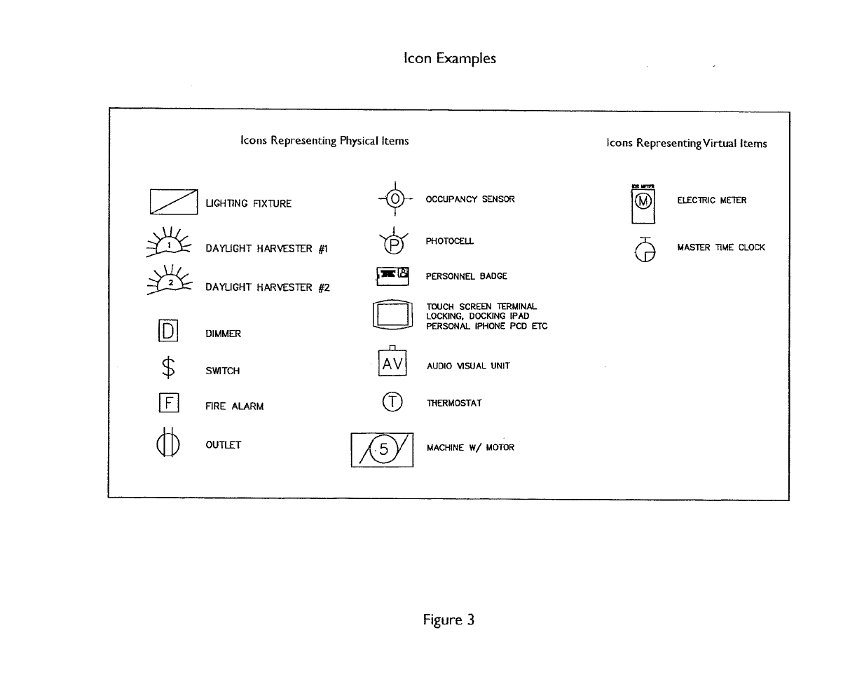

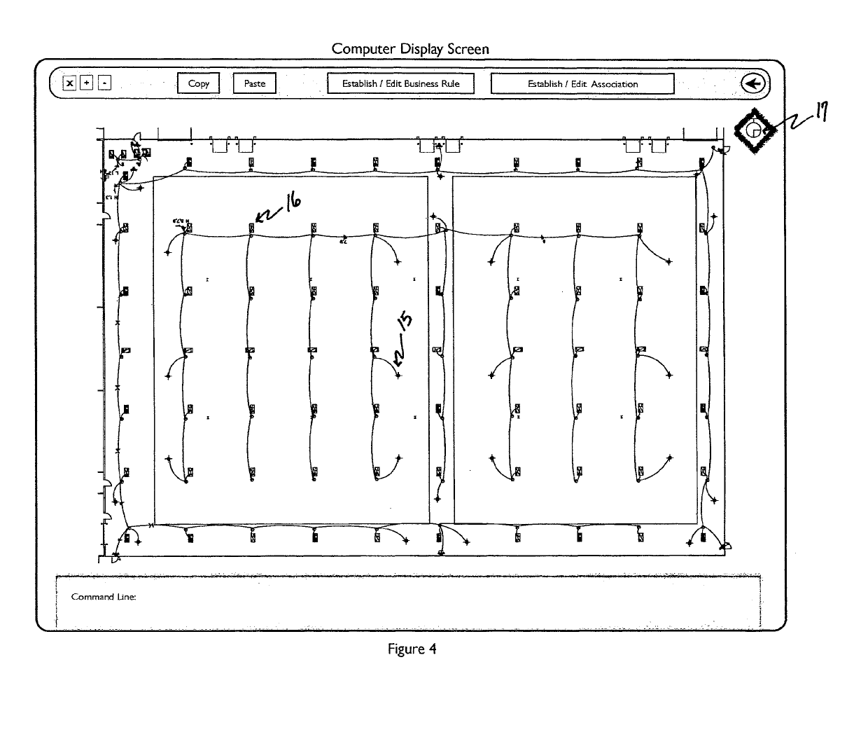

FIG. 3 depicts icon appearance of a system for designing, configuring, and reconfiguring operational relationships between one or more wireless control modules within a controlled environment according to one or more embodiments shown and described herein;

FIG. 4 depicts a computer display screen of a system for designing, configuring, and reconfiguring operational relationships between one or more wireless control modules within a controlled environment according to one or more embodiments shown and described herein;

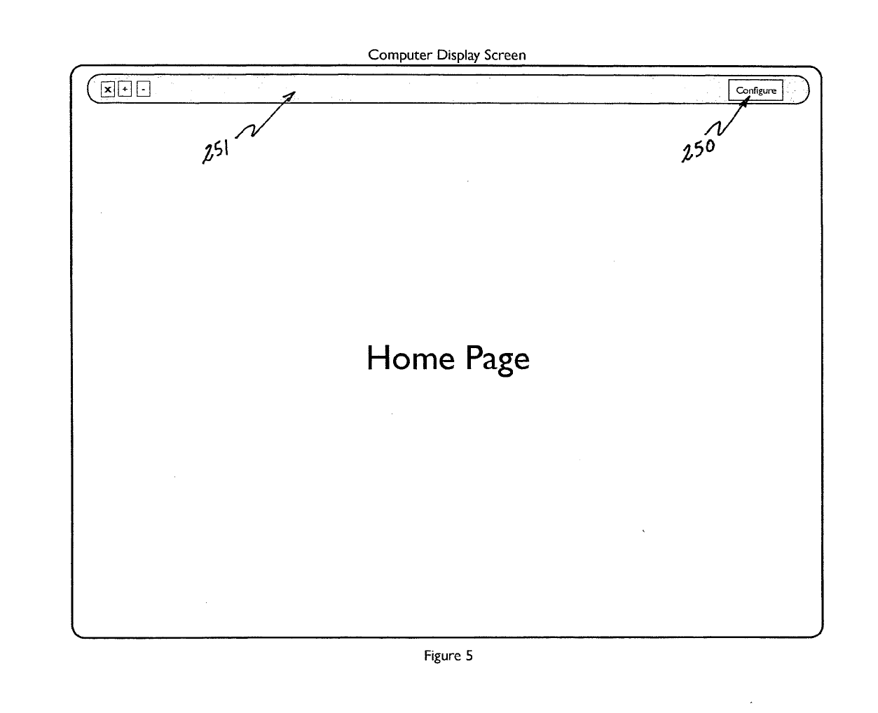

FIG. 5 depicts a computer display screen of a system for designing, configuring, and reconfiguring operational relationships between one or more wireless control modules within a controlled environment according to one or more embodiments shown and described herein;

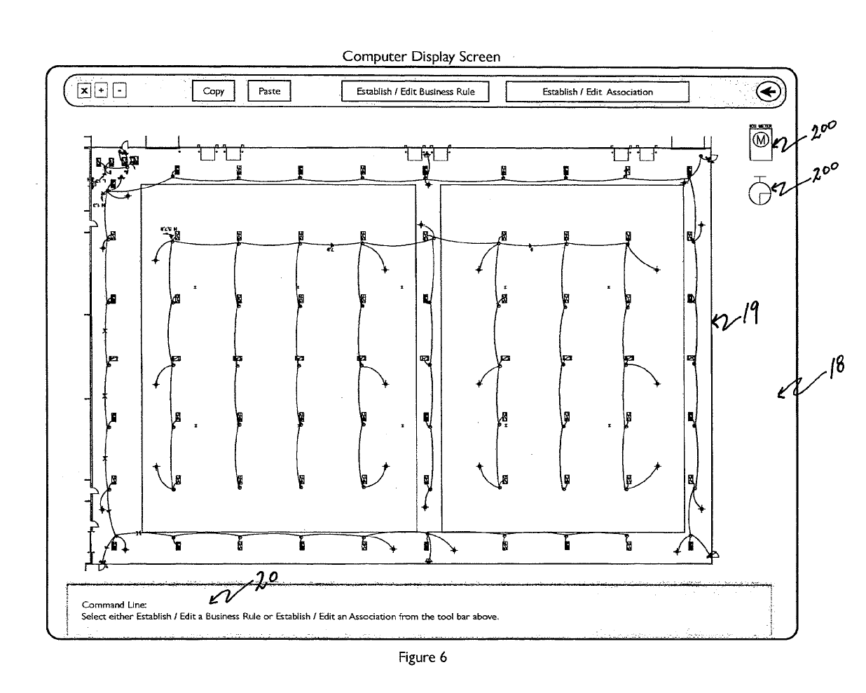

FIG. 6 depicts a computer display screen of a system for designing, configuring, and reconfiguring operational relationships between one or more wireless control modules within a controlled environment according to one or more embodiments shown and described herein;

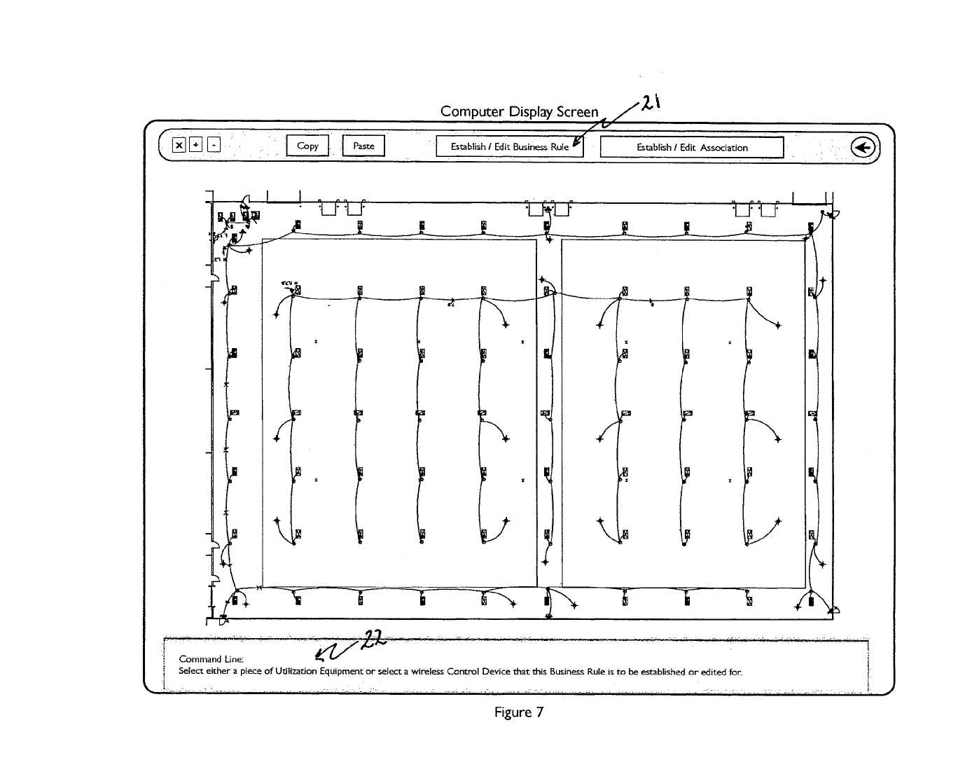

FIG. 7 depicts a computer display screen of a system for designing, configuring, and reconfiguring operational relationships between one or more wireless control modules within a controlled environment according to one or more embodiments shown and described herein;

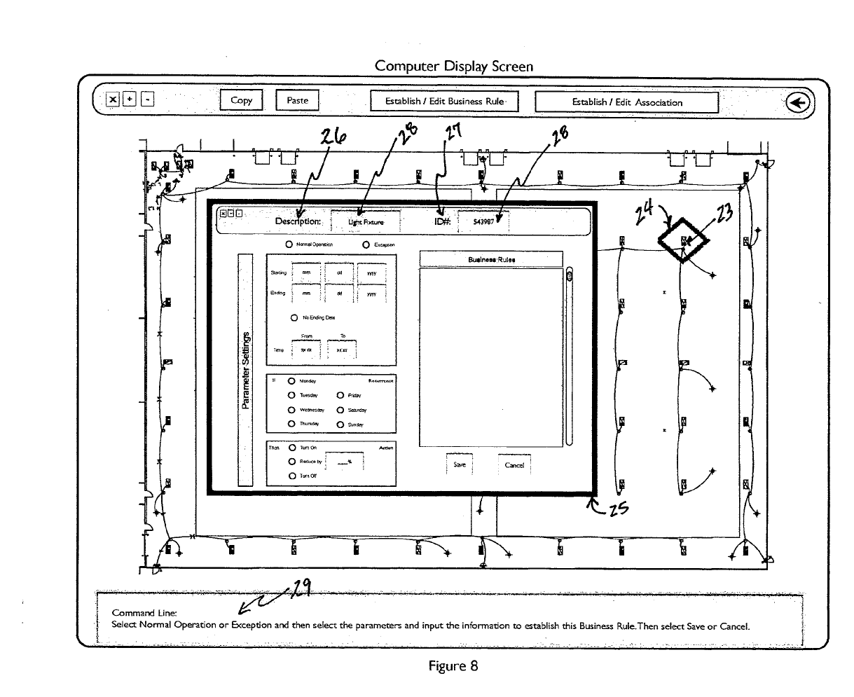

FIG. 8 depicts a computer display screen of a system for designing, configuring, and reconfiguring operational relationships between one or more wireless control modules within a controlled environment according to one or more embodiments shown and described herein;

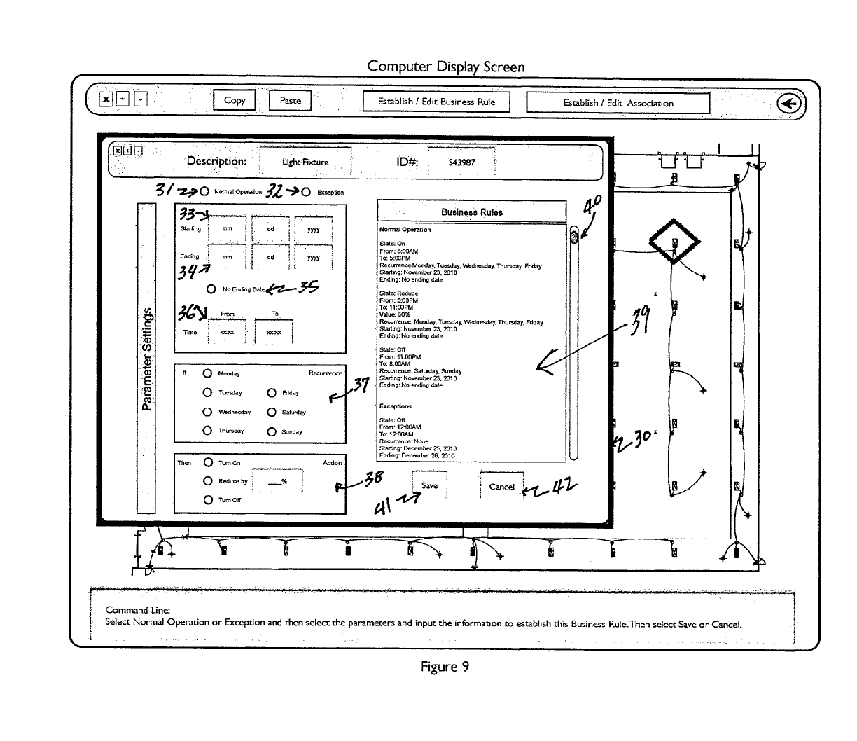

FIG. 9 depicts a computer display screen of a system for designing, configuring, and reconfiguring operational relationships between one or more wireless control modules within a controlled environment according to one or more embodiments shown and described herein;

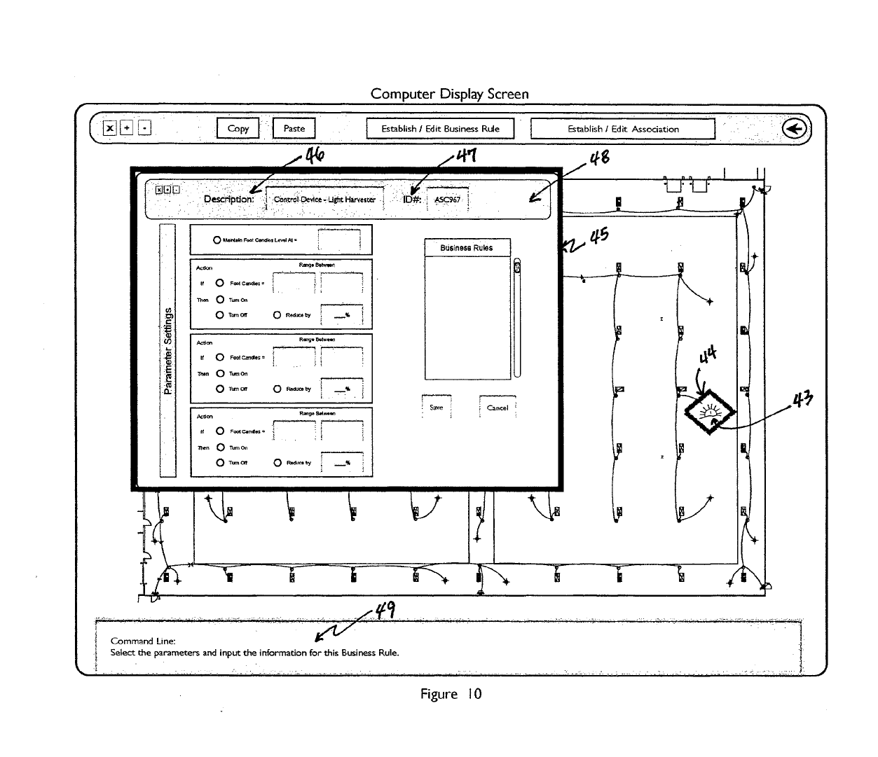

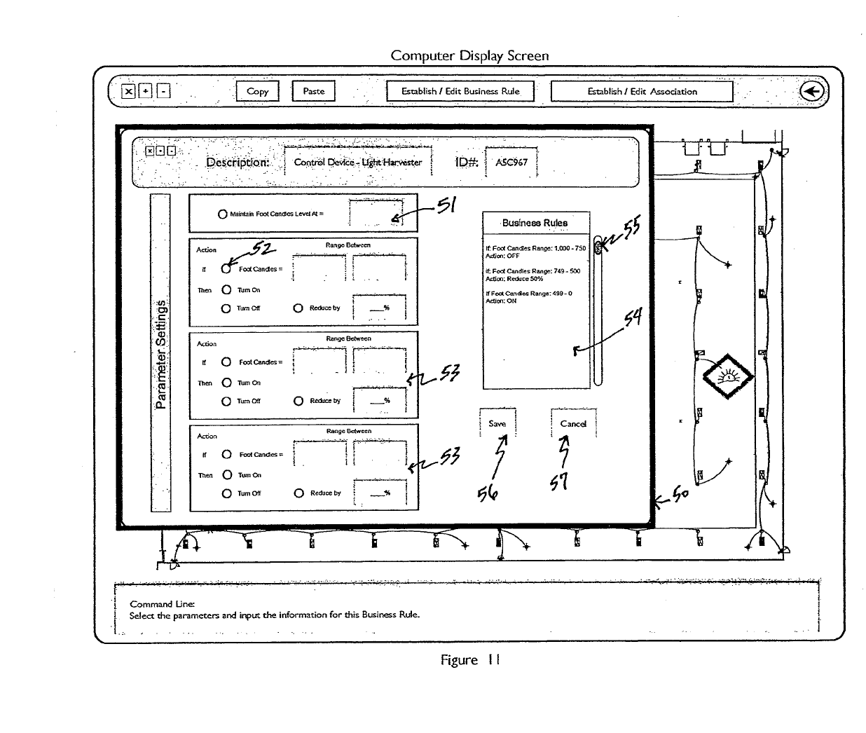

FIG. 10 depicts a computer display screen of a system for designing, configuring, and reconfiguring operational relationships between one or more wireless control modules within a controlled environment according to one or more embodiments shown and described herein;

FIG. 11 depicts a computer display screen of a system for designing, configuring, and reconfiguring operational relationships between one or more wireless control modules within a controlled environment according to one or more embodiments shown and described herein;

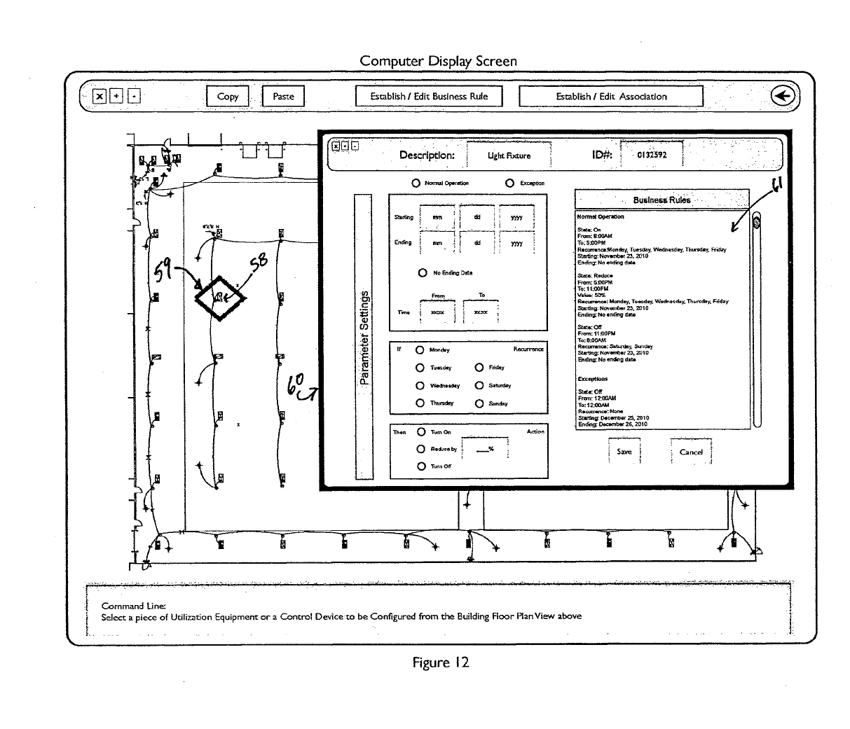

FIG. 12 depicts a computer display screen of a system for designing, configuring, and reconfiguring operational relationships between one or more wireless control modules within a controlled environment according to one or more embodiments shown and described herein;

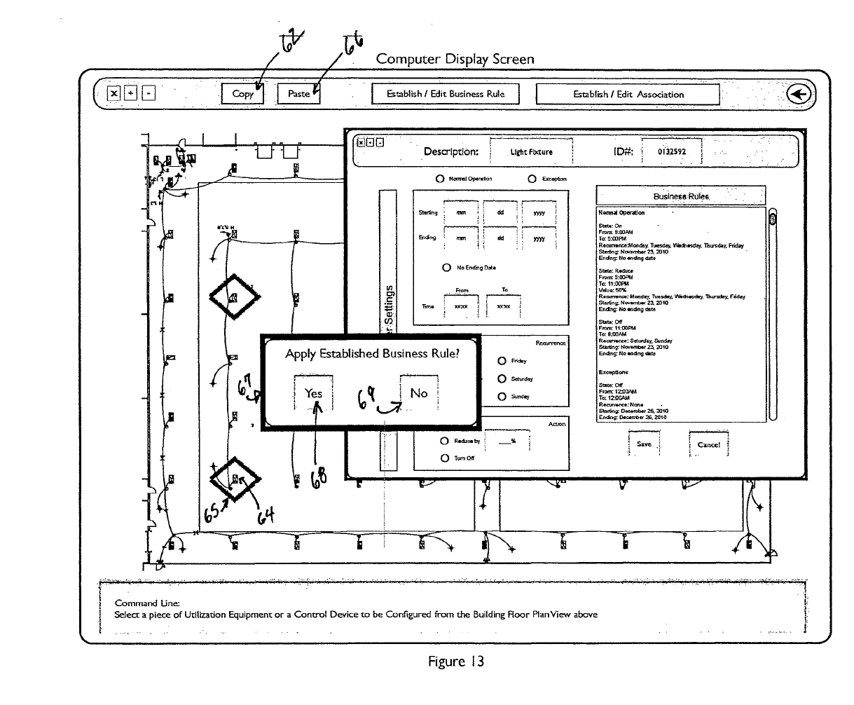

FIG. 13 depicts a computer display screen of a system for designing, configuring, and reconfiguring operational relationships between one or more wireless control modules within a controlled environment according to one or more embodiments shown and described herein;

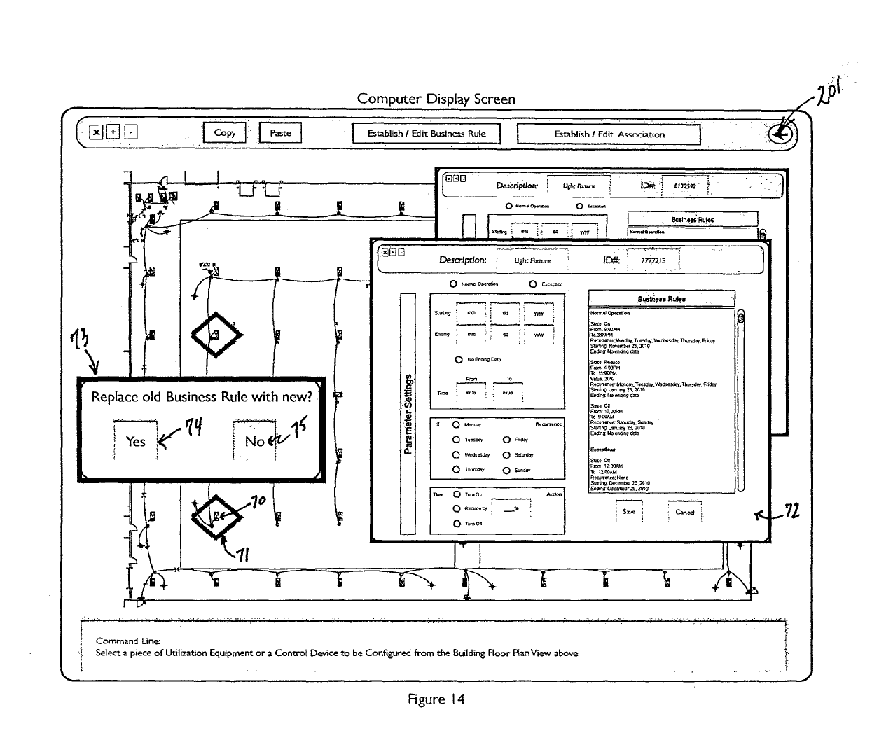

FIG. 14 depicts a computer display screen of a system for designing, configuring, and reconfiguring operational relationships between one or more wireless control modules within a controlled environment according to one or more embodiments shown and described herein;

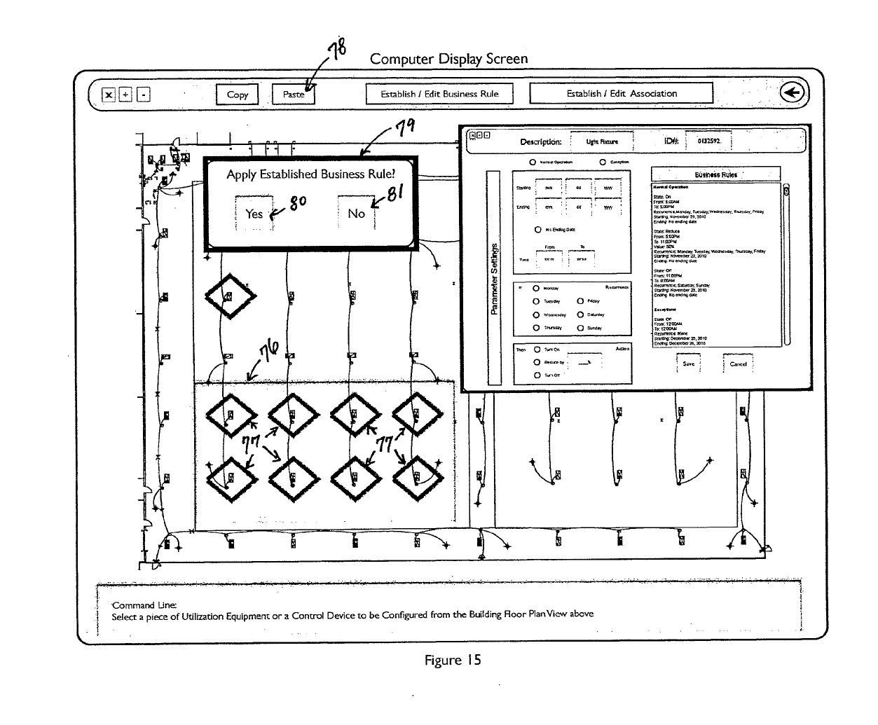

FIG. 15 depicts a computer display screen of a system for designing, configuring, and reconfiguring operational relationships between one or more wireless control modules within a controlled environment according to one or more embodiments shown and described herein;

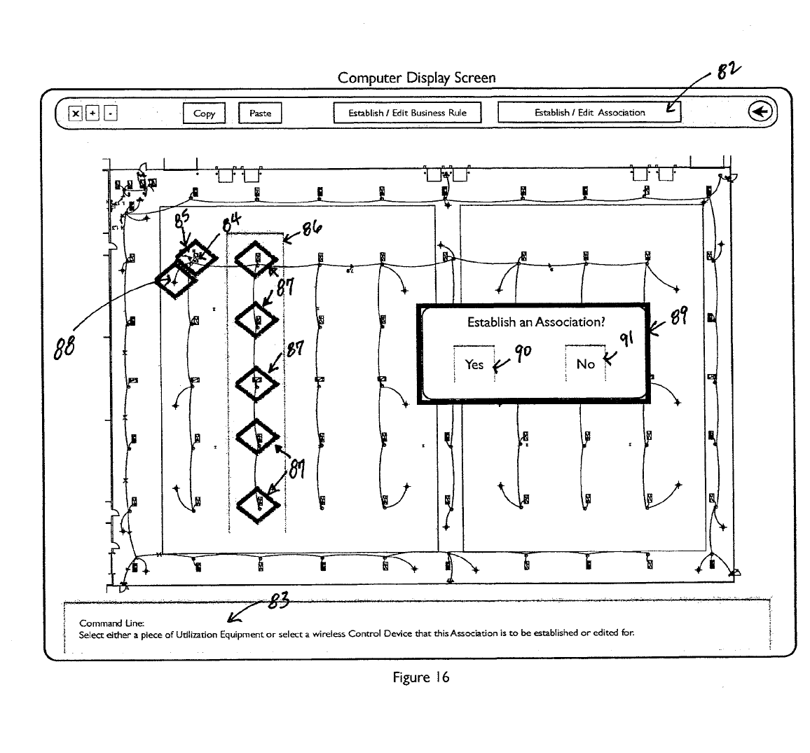

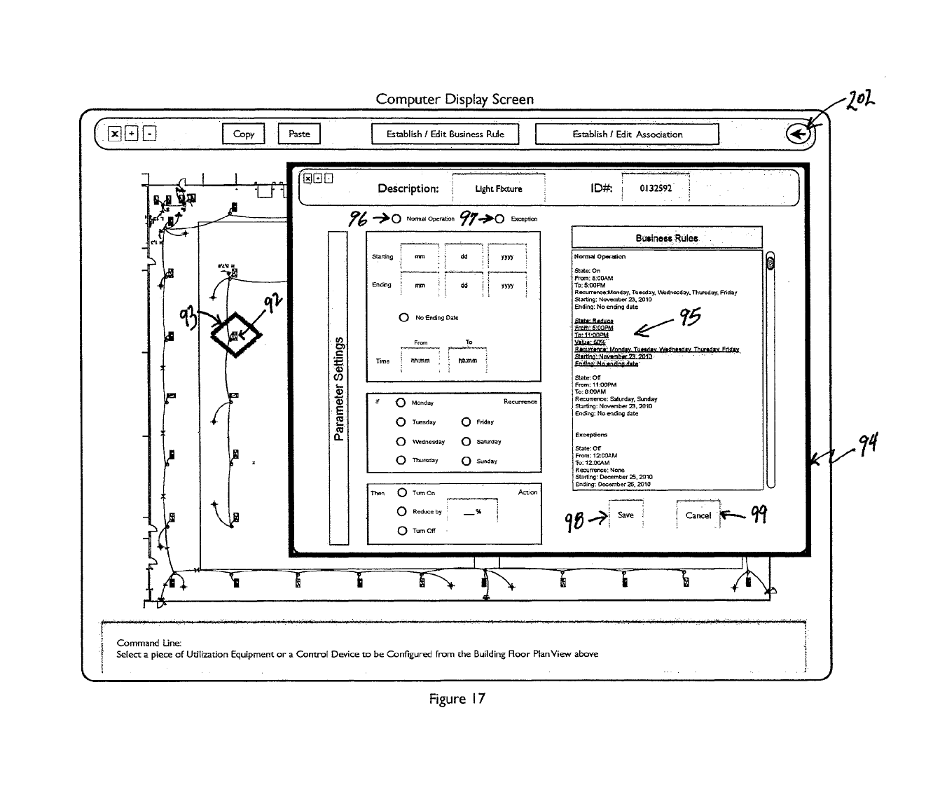

FIG. 16 depicts a computer display screen of a system for designing, configuring, and reconfiguring operational relationships between one or more wireless control modules within a controlled environment according to one or more embodiments shown and described herein;

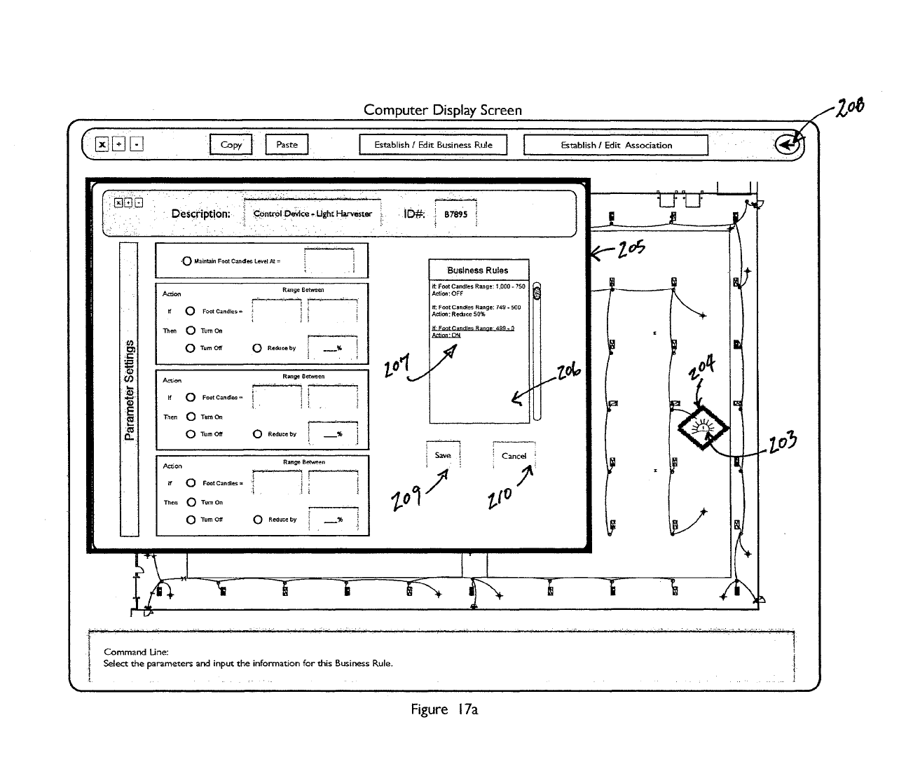

FIG. 17 depicts a computer display screen of a system for designing, configuring, and reconfiguring operational relationships between one or more wireless control modules within a controlled environment according to one or more embodiments shown and described herein;

FIG. 17a depicts a computer display screen of a system for designing, configuring, and reconfiguring operational relationships between one or more wireless control modules within a controlled environment according to one or more embodiments shown and described herein;

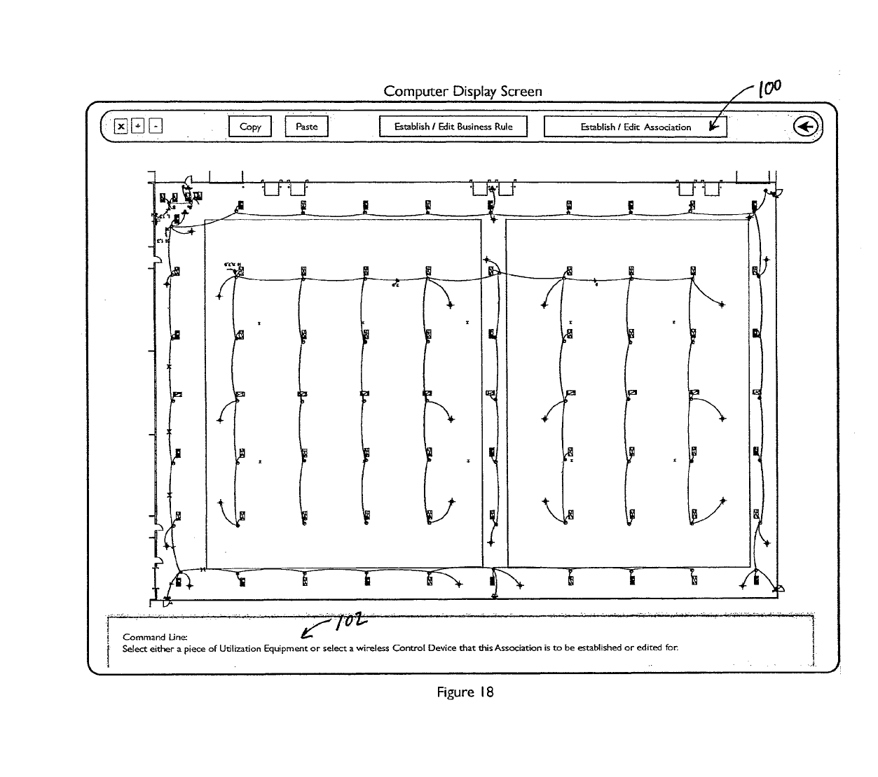

FIG. 18 depicts a computer display screen of a system for designing, configuring, and reconfiguring operational relationships between one or more wireless control modules within a controlled environment according to one or more embodiments shown and described herein;

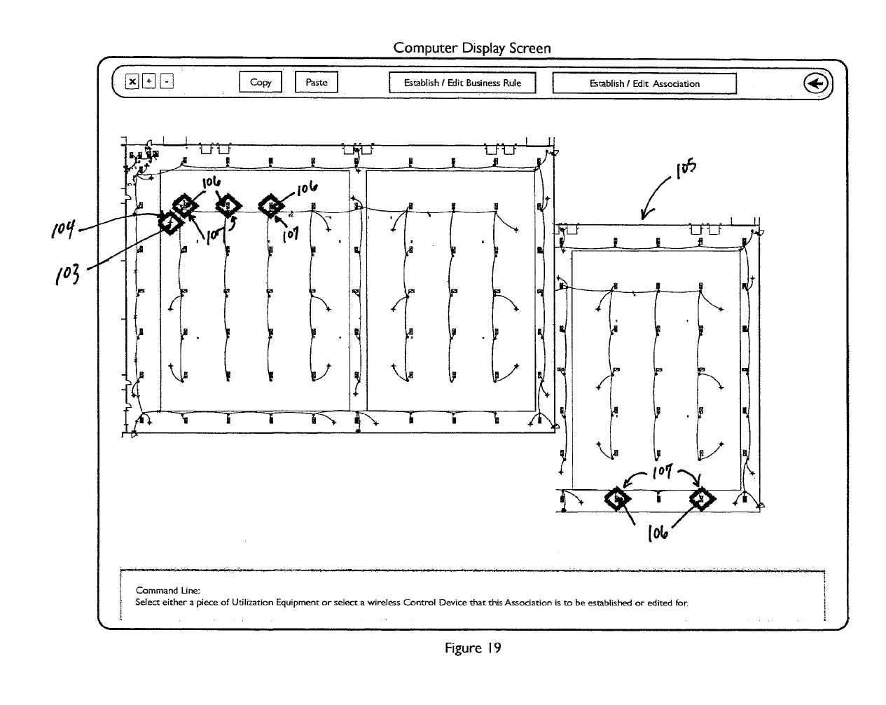

FIG. 19 depicts a computer display screen of a system for designing, configuring, and reconfiguring operational relationships between one or more wireless control modules within a controlled environment according to one or more embodiments shown and described herein;

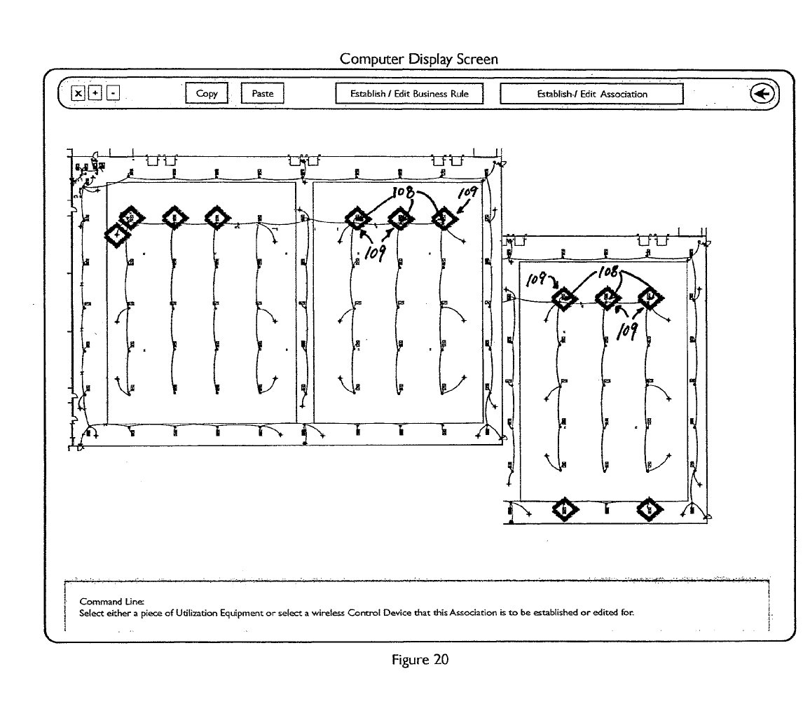

FIG. 20 depicts a computer display screen of a system for designing, configuring, and reconfiguring operational relationships between one or more wireless control modules within a controlled environment according to one or more embodiments shown and described herein;

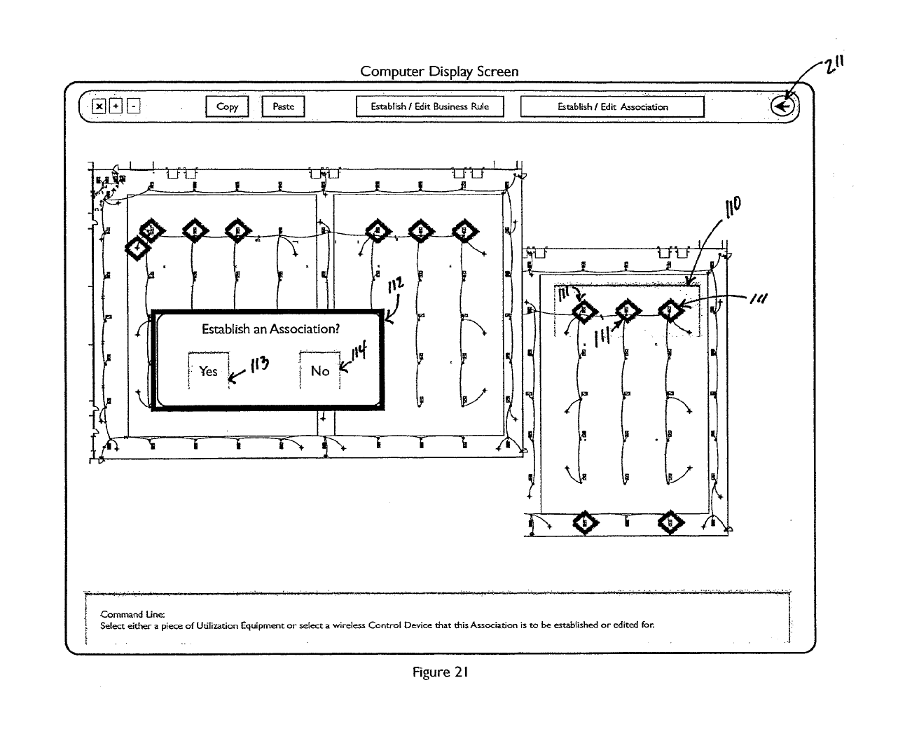

FIG. 21 depicts a computer display screen of a system for designing, configuring, and reconfiguring operational relationships between one or more wireless control modules within a controlled environment according to one or more embodiments shown and described herein;

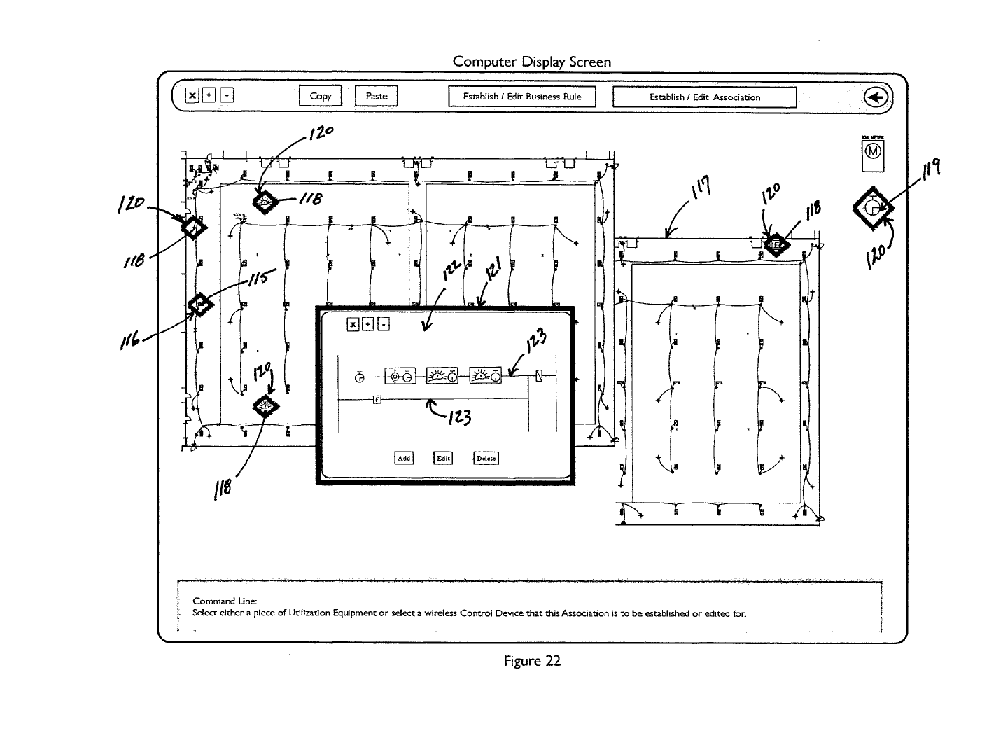

FIG. 22 depicts a computer display screen of a system for designing, configuring, and reconfiguring operational relationships between one or more wireless control modules within a controlled environment according to one or more embodiments shown and described herein;

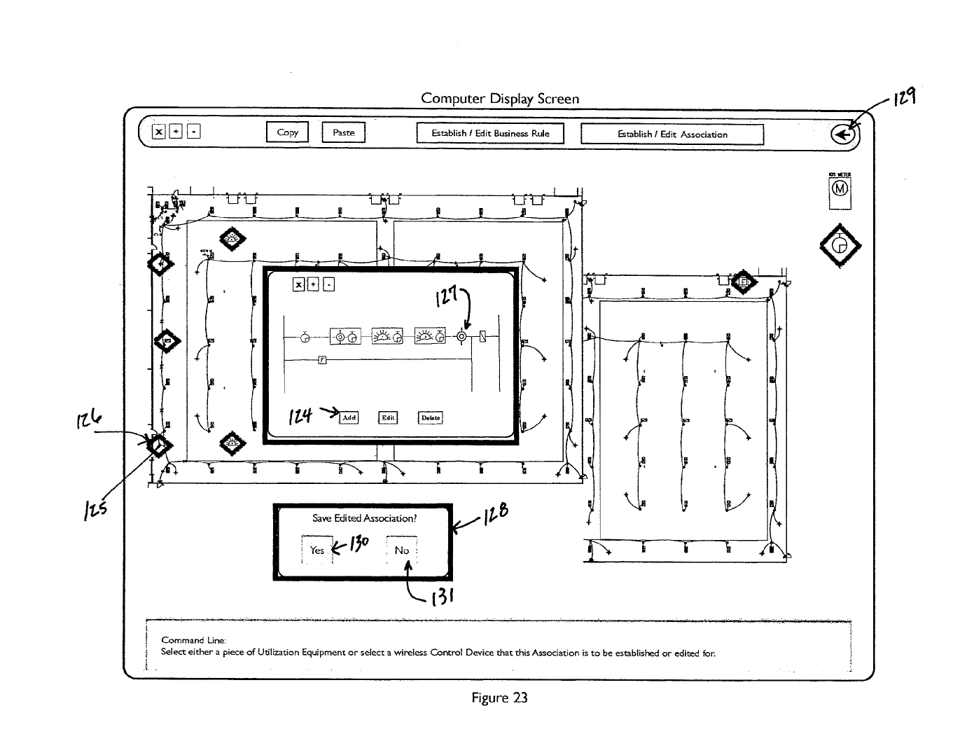

FIG. 23 depicts a computer display screen of a system for designing, configuring, and reconfiguring operational relationships between one or more wireless control modules within a controlled environment according to one or more embodiments shown and described herein;

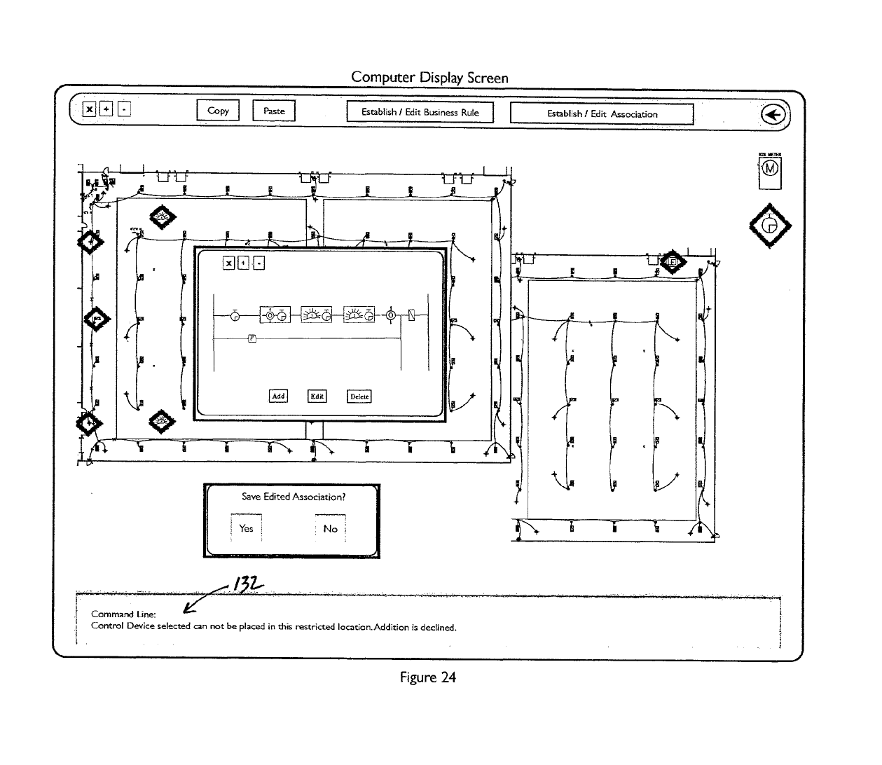

FIG. 24 depicts a computer display screen of a system for designing, configuring, and reconfiguring operational relationships between one or more wireless control modules within a controlled environment according to one or more embodiments shown and described herein;

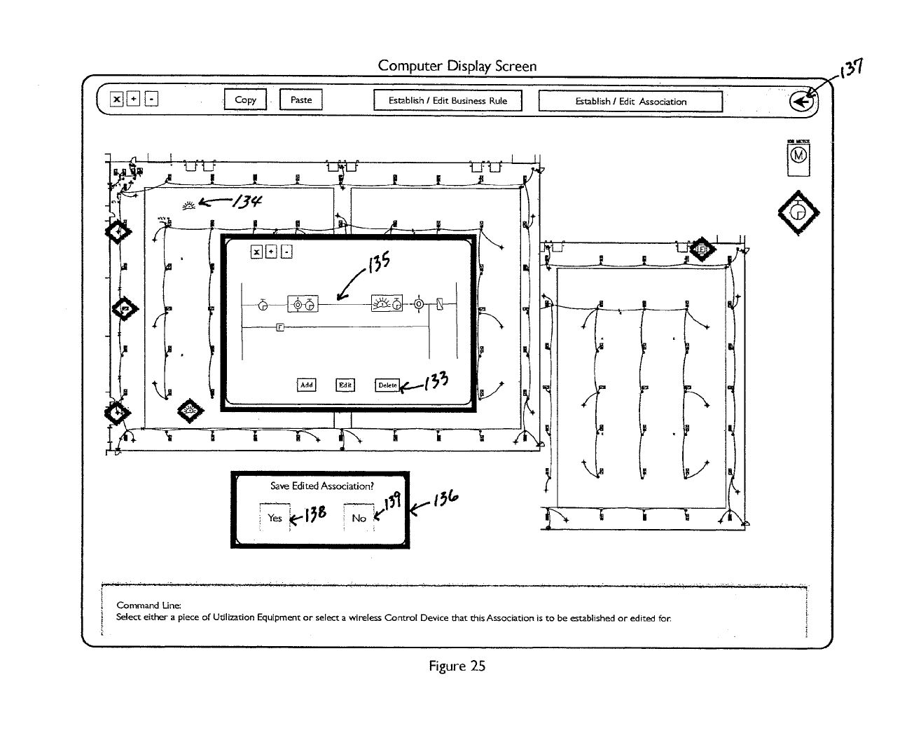

FIG. 25 depicts a computer display screen of a system for designing, configuring, and reconfiguring operational relationships between one or more wireless control modules within a controlled environment according to one or more embodiments shown and described herein; and

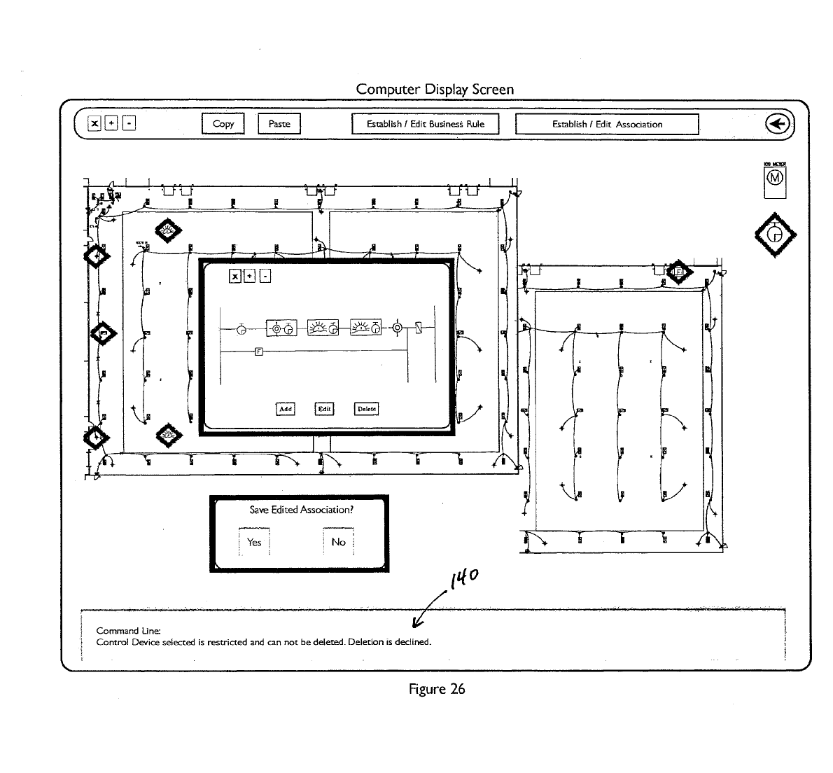

FIG. 26 depicts a computer display screen of a system for designing, configuring, and reconfiguring operational relationships between one or more wireless control modules within a controlled environment according to one or more embodiments shown and described herein.

Components that are impacted and influenced by the design and authorization system for wireless control reside within the Controlled Environment. As illustrated in FIG. 1, components within a Controlled Environment 1 are linked externally to an Electrical Utility 2 supplier, an Alternate Electrical Source 3 and linked to one or more pieces of Utilization Equipment 4.

The Controlled Environment as further illustrated in FIG. 1 comprises an Energy Management System 5 connected to one or more RF Transceivers 6. RF Transceivers wirelessly communicate 7 using radio frequency with one or more wireless Control Modules 8. Wireless Control Modules and Wireless Control Devices 9 each contain a unique radio frequency identification 10 (RFID).

Wireless Control Modules are each linked to individual pieces of Utilization Equipment and/or to an Alternate Electrical Source. Wireless Control Module functions may include, but not limited to, sending information and/or receiving instructions in the form of commands sent from the Energy Management System via the RF Transceiver, executing those commands and collecting data that is then sent back to the Energy Management System via the RF Transceiver.

Wireless Control Device functions may include, but not limited to, recognizing changes in the physical environment, measuring values and collecting data. Wireless Control Devices then wirelessly communicate this information back to the Energy Management System via radio frequency to the RF Transceiver. Information and data that is received from Wireless Control Modules and Wireless Control Devices are deposited and maintained within the Energy Management System's database.

A Remote Control Device 11 functions may include, but not limited to, communicating with the Energy Management System via the Internet 14 (World Wide Web) allowing the user to operate and maintain the Energy Management System from a remote location.

The design and authorization system for wireless control 12 is a software product that is integrated with a Computer-Aided Design (CAD) Software system 13 and with an Energy Management System 5 to provide extra functions, features and capabilities. The design and authorization system for wireless control includes Virtual Control Devices which recognize intangible measures such as time, date, and other data. This software product is used both within the Controlled Environment 1 when integrated with an Energy Management System 5 and is used external to the Controlled Environment when integrated with a Computer-Aided Design (CAD) Software system 13.

A Wireless Control Module is a device that monitors and controls the operation of an individual piece of Utilization Equipment and/or an Alternate Electrical Source. Every individual piece of Utilization Equipment and Alternate Electrical Source is linked to a separate Wireless Control Module. Each Wireless Control Module maintains a unique electronic radio frequency identity (RFID); wirelessly communicates with the Energy Management System; accepts commands issued from the Energy Management System as transmitted from the RF Transceiver; executes commands; and/or wirelessly communicates a variety of data and information back to the Energy Management System via the RF Transceiver.

Specific to the piece of Utilization Equipment or to the Alternate Electrical Source that a Wireless Control Module is linked to, the Wireless Control Module can use radio frequency to establish wireless communication with the RF Transceiver; measures electrical current and voltage; recognizes the piece of Utilization Equipment's present operating state (e.g.: on, off, dimmed, speed, position, etc.); measures state-of-health; receive information requests and commands from the Energy Management System; executes commands that it receives; and/or transmits information and state-of-health conditions and other data to the RF Transceiver.

A Wireless Control Device functions as a sensor to recognize and measure conditions within the general environment (for example: current, voltage, motion, presence, temperature, ambient light level, motor speed. position, etc.); to maintain a unique electronic radio frequency identity (RFID); and/or to use radio frequency to wirelessly communicate this information to the RF Transceiver. Wireless Control Devices may be logically related (Associated) through software parameters to individual pieces of Utilization Equipment via the Wireless Control Modules that the pieces of Utilization Equipment are linked to.

A Virtual Control Device is software logic that recognizes and measures conditions that are typically intangible (such as time, date, and other data). Virtual Control Devices are logically related (Associated) through software parameters to individual pieces of Utilization Equipment via the Wireless Control Modules that the pieces of Utilization Equipment are linked to.

Computer-Aided Design Software are commercially available software products that allows designs (drawings, floor plans, etc.) to be created using a computer.

The design and authorization system for wireless control is a software product comprising, but not limited to, application software and a database that can be added to (integrated with) a Computer-Aided Design (CAD) Software system and to an Energy Management System to provide additional enhanced functions and features including, but not limited to, the ability to create Virtual Control Devices. A Virtual Control Device (such as a timer, a meter, etc.) is a piece of software logic that is controlled similarly to Wireless Control Devices.

The design and authorization system for wireless control software product is used both within the Controlled Environment when integrated with an Energy Management System and is used external to the Controlled Environment when integrated with a Computer-Aided Design (CAD) System. When integrated with the Computer-Aided Design (CAD) Software the design and authorization system for wireless control software product becomes a seamless part of the Computer-Aided Design (CAD) Software system. When integrated with Energy Management System the design and authorization system for wireless control software product becomes a seamless part of the Energy Management System.

Generally, the function of the Energy Management System illustrated in FIG. 1, when integrated with the design and authorization system for wireless control software is to provide the Energy Management System operator with overall management and control of all components within the Controlled Environment. The Energy Management System then provides: real-time and historical visibility to electrical usage; performance data of each piece of Utilization Equipment; and management and control over the source of electrical supply and the amount of electricity consumed by Utilization

Equipment. More specifically, the Energy Management System comprises a programmable computer with a user interface, a Computer Display Screen, a mouse, a keyboard, a database, and I/O ports suitable for communicating with components of the Controlled Environment.

One or more RE Transceivers are linked to the Energy Management System. RF Transceivers receive instructions from the Energy Management System and wirelessly communicate commands to one or more Wireless Control Modules using radio frequency communication. RF Transceivers also wirelessly communicate using radio frequency with one or more Wireless Control Devices and Wireless Control Modules to receive information and to pass that information on to the Energy Management System.

The function of the Remote Control Device as further illustrated in FIG. 1 is to provide authorized users and system operators access from a remote location to the Visibility Functions and to the Management & Control Functions of the Energy Management System outlined previously. The Remote Control Device is a Personal Computer or a small hand-held type device that communicates via the Internet (World Wide Web) with the Energy Management System. Authorization levels established within the Energy Management System determine which functions the operator using the Remote Control Device may perform.

Referring to FIG. 1 the function of the Electrical Utility is to supply electrical power and provide historical and on-going electrical usage data to customers. Historical and current electrical usage data is stored along with other data elements in the Energy Management System database.

The function of the Alternate Electrical Source (e.g.: a generator, solar, wind power, fuel cell, etc.) is to be available to provide an alternate and/or supplemental electrical power source to that provided by the Electrical Utility supplier.

Utilization Equipment is any product or piece of equipment that utilizes electric energy for electronic, electromechanical, chemical, heating, lighting, or similar purposes. The function of a piece of Utilization Equipment (e.g.: a light fixture, a motor, HVAC, range/oven, dryer, etc.) is to fulfill its designed purpose for the user.

A high-level description of the various design and authorization system for wireless control process steps followed to Design, Configure and Reconfigure the operational relationships between one or more Wireless Control Modules and one or more Wireless Control Devices and/or Virtual Control Devices within a Controlled Environment is depicted in FIG. 2.

Three high level processes define how the design and authorization system for wireless control works: The Design Process: The Configure Process; and The Reconfigure Process. Each is described below.

The operator can use the Design Process to design the operational relationships between Wireless Control Modules and Wireless Control Devices the operator first installs the design and authorization system for wireless control software product, comprising application software and a database, onto the user's computer system that has Computer-Aided Design (CAD) Software already installed. The design and authorization system for wireless control software product operates seamlessly with the operator's Computer-Aided Design (CAD) Software allowing the operator to create and modify Building Floor Plan Drawings and input other relevant information into the design and authorization system for wireless control database. The Computer-Aided Design (CAD) Software draws upon the design and authorization system for wireless control software for added features, functions, capabilities and information required to design a Building Floor Plan Drawing to include, but not limited to, placement of Wireless Control Modules, Wireless Control Devices and Virtual Control Devices.

In conjunction with the Computer-Aided Design (CAD) Software, the design and authorization system for wireless control software provides numerous ICONS as illustrated in FIG. 3 that the operator uses to design the Building Floor Plan Drawing. These ICONS are used by the operator to represent both physical devices (such as: wireless Control Devices and wireless Control Modules, pieces of Utilization Equipment, etc.) and virtual devices (such as: virtual Electric Meters and virtual Master Time Clocks, etc.).

As illustrated in FIG. 4 iconic representations of physical Wireless Control Devices (for example: an Occupancy Sensor 15), Wireless Control Modules (for example: a Light Fixture 16) are designed into the Building Floor Plan Drawing in specific locations which are representative of where they are to be physically installed. The iconic representations of Virtual Control Devices 17 are designed into the Building Floor Plan Drawing and appear in the upper right hand corner of the operator's Computer Display Screen since they are intangible items.

During the Design Process the Computer-Aided Design Software inputs information; captures operator data entries and system generated data; and/or creates computer various software files. The design and authorization system for wireless control provides a Synch Procedure to transfer this Computer-Aided Design Software files to the design and authorization system for wireless control database. Through the Synch Procedure the design and authorization system for wireless control prompts the operator to input all of the required and optional data elements that the design and authorization system for wireless control needs and that may be missing following each Synch Procedure. The operator can repeat the Synch Procedure as often as desired to ensure all of the required information has been input and transferred.

The data elements that are either required and/or optional that are transferred from the Computer-Aided Design (CAD) Software system to the design and authorization system for wireless control through the Synch Procedure include, but are not limited to:
Building Floor Plan Drawings including placement of all Wireless Control Devices and Wireless Control Modules
Description of each piece of Utilization Equipment (for example: light fixture, motors, heating unit. etc.), Wireless Control Device (for example: motion detector, occupancy sensor, light harvester, etc.), Virtual Control Device and Wireless Control Module
Identification Number of each piece of Utilization Equipment, Wireless Control Device, Virtual Control Device and Wireless Control Module
Location of each piece of Utilization Equipment, Wireless Control Device and Wireless Control Module (x/y coordinates, floor level, building number, etc.)
Date that each piece of Utilization Equipment, Wireless Control Device and Wireless Control Module was physically installed
Manufacturer's Information for each piece of Utilization Equipment, Wireless Control Device and Wireless Control Module (brand name, serial number, model number, part number)
Indication for each piece of Utilization Equipment, Wireless Control Device and Wireless Control Module if it is battery operated (yes/no)
Maintenance Information for each piece of Utilization Equipment, Wireless Control Device and Wireless Control Module (replacement parts description, part numbers, etc.; consumable parts description, part numbers, etc.)
Operational Information for each piece of Utilization Equipment (upper performance threshold, lower performance threshold, etc.)

Once the design and authorization system for wireless control database has been built through completion of the Synch Procedure the user proceeds to the Configure Process.

The Configure Process is used to establish the operational relationships between one or more Wireless Control Modules and one or more Wireless Control Devices and/or Virtual Control Devices within a Controlled Environment.

Operational relationships between Wireless Control Devices and Wireless Control Modules are established through the design and authorization system for wireless control Configure Process. The Configure Process includes, but not limited to, three activities: (1) Establishment of Business Rules; (2) Establishment of Associations, and (3) Authorization of Wireless Control Modules and Wireless Control Devices after they are physically installed in the building structure. Business Rules define the conditions by which a Wireless Control Module and a Wireless Control Device and/or Virtual Control Device take action. Associations define how Wireless Control Modules and Wireless Control Devices and/or Virtual Control Devices are related to one another. Authorization establishes the system's software logic and Building Floor Plan Drawings with the physical presence and location of Wireless Control Modules and Wireless Control Devices.

Within the Configure Process the operator establishes Business Rules by selecting software parameters and inputing other information that define the conditions by which a Wireless Control Module and a Wireless Control Device take action.

As illustrated in FIG. 5, to establish a Business Rule within the Configure Process, the operator clicks on the Configure button 250 on the Tool Bar 251 that appears on the design and authorization system for wireless control home page on the Computer Display Screen.

As illustrated in FIG. 6 this action causes a new window 18 to appear; the Building Floor Plan Drawing 19 to be retrieved from the system's database and displayed on the screen; all virtual Control Devices 200 to appear on the screen; and a message to display in the Command Line 20 at the bottom of the screen prompting the operator to select either Establish/Edit a Business Rule or Establish/Edit an Association from the tool bar above.

As illustrated in FIG. 7 the operator clicks on the Establish/Edit a Business Rule button 21. This action causes a message 22 to display in the Command Line at the bottom of the screen prompting the operator to select either the piece of Utilization Equipment or select the Wireless Control Device that the Business Rule is to be established for.

Every piece of Utilization Equipment has a Wireless Control Module linked to it, thus, on the Building Floor Plan Drawing, a Wireless Control Module is represented by the icon of the piece of Utilization Equipment to which it is linked. From the Building Floor Plan Drawing the operator makes the selection by clicking on the icon that represents the desired piece of Utilization Equipment or the Wireless Control Device to be configured.

As illustrated in FIG. 8 clicking of an icon that represents a piece of Utilization Equipment 23 from the Building Floor Plan Drawing causes that icon to become highlighted 24 and a Parameter Setting Window 25 to open on the Computer Display Screen. This Parameter Setting Window provides the operator with numerous operating parameter settings that can be input, selected and saved. The Description 26 and the I.D.# 27 of the piece of Utilization Equipment (as an example in this illustration a Light Fixture #543987) are pulled from the system's database and are populated in the parameter window's Tool Bar 28. Every category of Utilization Equipment (light fixture, motor, heating unit, etc.) has its own unique parameter window comprising parameter setting selections applicable to that category of Utilization Equipment. The appropriate Parameter Setting Window is included in the design and authorization system for wireless control software and is retrieved from the system's database. Information appears in the Command Line at the bottom of the screen 29 prompting the operator to select Normal Operation or Exception, select the parameters and input information to establish the Business Rule. The parameters input and selected by the operator establish the specific Business Rules by which that piece of Utilization Equipment will operate.

FIG. 9 depicts a closer drawing of a Parameter Setting Window 30 for a piece of Utilization Equipment. As further illustrated in FIG. 9 the operator chooses if the parameters to be input and selected are to be applied to the Normal Operation 31 of the piece of Utilization Equipment or if the parameters to be input and selected are to be applied as an Exception 32 to the Normal Operation. Exceptions override the parameters established for Normal Operation. The operator inputs the desired date range that this business rule wilt be in effect by inputing the Starting Date 33 (month, day, year) and the desired Ending Date (month, day, year) 34, or No Ending Date 35. The operator also inputs the Time 36 the business rule should begin and end during the date range input. The operator selects the recurring days 37 (every: Monday, Tuesday, Wednesday, Thursday, Friday, Saturday, Sunday) during the date range that the business rule applies and also selects and inputs the actions to be taken 38 (Turn On, Reduce by ______ %, Turn Off) on those days within the date range and time parameters input.

As further illustrated in FIG. 9 as the operator inputs and selects each parameter the Business Rule results 39 appear on the right side of the screen providing the operator with a visual description of the Business Rule being established. The operator uses the scroll bar 40 to view Business Rule information that is not presently visible in the window. The operator saves the established business rule in the design and authorization system for wireless control database by clicking on the Save button 41 and the parameter setting window closes and disappears from view. The operator cancels the parameter settings input by clicking on the Cancel button 42 and all of the selected and input parameters will be cleared from the Parameter Setting Window.

As illustrated in FIG. 10 clicking of an icon that represents a Wireless Control Device 43 from the Building Floor Plan Drawing causes that icon to become highlighted 44 and a new Parameter Setting Window 45 to open on the Computer Display Screen providing the operator with numerous operating parameter settings that can input, selected and saved. The Description 46 and the I.D.# 47 of the Wireless Control Device are pulled from the system's database and populated in the parameter window's Tool Bar 48. Every category of Wireless Control Device (for example: motion detector, occupancy sensor, light harvester, etc.) has its own unique parameter window comprising parameter setting selections applicable to that category of Wireless Control Device. The appropriate Parameter Setting Window is included in the design and authorization system for wireless control software and is retrieved from the system's database. information appears in the Command Line 49 at the bottom of the screen prompting the operator to select the parameters and input information to establish this Business Rule. The parameters input and selected by the operator establish the specific Business Rules by which that Wireless Control Device will operate.

FIG. 11 depicts a closer Drawing of the Parameter Setting Window 50 for a Wireless Control Device (in this illustration as an example: a Light Harvester, ID# A5C967). As further illustrated in FIG. 11 the operator inputs and selects the parameters that are to be applied to the selected Wireless Control Device. The operator can input the value for the level of Foot Candles to be maintained 51. Selecting this parameter and inputing a value will result in all Light Fixtures that have a relationship with this Wireless Control Device to automatically dim, or brighten, to the extent necessary to maintain the Foot Candle level established in the Business Rule for this Wireless Control Device. Alternatively, the operator can determine specific action to be taken 52 (turn ON when range is between A and D; Turn OFF when range is between C and D; or Reduce the level (dim) by a desired percentage) whenever the level of Foot Candles falls between a specific Range by inputing the appropriate information. The operator can input multiple ranges and actions 53.

As further illustrated in FIG. 11 as the operator inputs and selects each parameter the results 54 appear on the right side of the screen providing the operator with a visual description of the Business Rule being established. The operator uses the scroll bar 55 to view Business Rule information that is not presently visible in the window. The operator saves the established business rule in the design and authorization system for wireless control database by clicking on the Save button 56 and the Parameter Setting Window closes and disappears from view. The operator cancels the parameter settings input by clicking on the Cancel button 57 and all of the selected and input parameters will be cleared from the Parameter Setting Window.

To speed the process of configuring Wireless Control Modules and Wireless Control Devices within the Configuration Process the operator can copy and paste a Business Rule that has previously been establish for one Wireless Control Module or Wireless Control Device over to another equal type Wireless Control Module (for example: copying from one Light Fixture to another Light Fixture) or equal type Wireless Control Device (for example: copying from one Motion Detector to another Motion Detector).

To Copy and Paste an already established Business Rule within the Configure Process, as illustrated in FIG. 5, the operator clicks on the Configure button 16 on the Tool Bar 17 that appears on the design and authorization system for wireless control home page on the Computer Display Screen.

As illustrated in FIG. 6 this action causes a new window 18 to appear; the Building Floor Plan Drawing 19 to be retrieved from the system's database and displayed on the screen; all virtual Control Devices 200 to appear on the screen; and a message to display in the Command Line 20 at the bottom of the screen prompting the operator to select either Establish/Edit a Business Rule or Establish/Edit an Association from the tool bar above.

As illustrated in FIG. 7 the operator clicks on the Establish/Edit a Business Rule button 21. This action causes a message 22 to display in the Command Line at the bottom of the screen prompting the operator to select either the piece of Utilization

Equipment or select the Wireless Control Device that the Business Rule is to be established for. As previously stated, every piece of Utilization Equipment represented in the Building Floor Plan Drawing has a Wireless Control Module linked to it, thus on the Building Floor Plan Drawing a Wireless Control Module is represented by the icon of the piece of Utilization Equipment to which it is linked.

As illustrated in FIG. 12 from the Building Floor Plan Drawing the operator clicks on the icon that represent either the piece of Utilization Equipment or the Wireless Control Device that the Business Rule is to be copied from. This action causes the selected icon 58 to become highlighted 59 and the Parameter Setting Window 60 containing the Business Rules 61 that have previously been established for the selected Wireless Control Module or Wireless Control Device (in this illustration as an example: a Light Fixture ID# 0132592) to be retrieved from the system's database and appear on the Computer Display Screen.

As illustrated in FIG. 13 to copy this Business Rule the operator clicks on the Copy button 62 in the Tool Bar 63 and then clicks on the piece of Utilization Equipment or Wireless Control Device that the Business Rule is to be applied (pasted) to. This action will cause the selected icon 64 to become highlighted 65. The operator then clicks on the Paste button 66 in the Tool Bar which causes a new window 67 to open asking the operator to confirm that the established Business Rule should be applied (pasted) to the icon 64 highlighted. The operator clicks the Yes button 68 and the established Business Rule is applied (pasted) to the selected icon 64, the information is saved in the system's database, the Parameter Setting Window disappears from view, and the system reverts back to the Building Floor Plan Drawing on the Computer Display Screen. The operator clicks the No button 69 and the Parameter Setting Window disappears from view, the selected icon 64 that the Business Rules were to be applied (pasted) to is no longer highlighted and the system reverts back to displaying the Building Floor Plan Drawing.

If a Business Rule had already previously been established for the selected piece of Utilization Equipment or Wireless Control Device that the Business Rule is to be applied (pasted) to, then as illustrated in FIG. 14 the selected icon 70 will become highlighted 71 and the Parameter Setting Window 72 containing the Business Rules that have previously been established for the selected piece of Utilization Equipment (as an example in this illustration: a Light Fixture ID# 7777213) or Wireless Control Device to appear on the Computer Display Screen. A new window opens 73 asking the operator to confirm that the existing Business Rule for the selected icon 70 should be replaced with the new Business Rules. When the operator clicks the Yes button 74 the Business Rule is applied (pasted) to the selected icon 70, the information is saved in the system's database, the Parameter Setting Windows disappear from view, and the system reverts back to the Building Floor Plan Drawing on the Computer Display Screen. When the operator clicks the No button 75 the Parameter Setting Windows disappear from view, the selected icon 70 that the Business Rule was to be applied (pasted) to is no longer highlighted and the system reverts back to displaying the Building Floor Plan Drawing. Alternatively, the operator can use the Reverse button 201 to cancel the selection and revert back to the previous state.

As illustrated in FIG. 15 the operator can choose to apply (paste) an established Business Rule to multiple pieces of Utilization Equipment or Wireless Control Devices in one activity by holding down the left mouse button and moving the pointer over the pieces of Utilization Equipment or Wireless Control Devices that the Business Rule is to be applied (pasted) to. As the operator performs this action the area selected becomes framed 76 and all of the same type icons (in this illustration they are all Light Fixtures, no other types of Utilization Equipment) within the selection area become highlighted 77. The operator can include additional like kind pieces of Utilization Equipment or Wireless Control Devices in the copy and paste activity by holding down the shift key on the computer keyboard and clicking of the individual icon(s) to be included. This action causes the selected icon(s) to also become highlighted and included in the immediate copy and paste activity.

Icons that are highlighted can be excluded from the immediate copy and paste activity underway by holding down the shift key on the computer keyboard and clicking of the individual icon(s) to be excluded. This action will cause the icon to no longer be highlighted and the represented piece of Utilization Equipment or wireless Control Device will not be included in the current copy and paste activity. All other previously selected icons remain highlighted.

As further illustrated in FIG. 15 after all of the icons have been selected the operator clicks on the Paste button 78 in the Tool Bar which causes a new window 79 to open asking the operator to confirm that the Business Rule should be applied (pasted) to all highlighted icons. When the operator clicks the Yes button 80 the Business Rule is applied to the highlighted icons; the information is saved in the system's database; the new window 70 and the Parameter Setting Window disappear from view; and the system reverts back to the Building Floor Plan Drawing on the Computer Display Screen. When the operator clicks the No button 81 the new window 79 and the Parameter Setting Window disappear from view; the selected icon(s) that the Business Rule was to be applied (pasted) to will no longer be highlighted and the system reverts back to displaying the Building Floor Plan Drawing.

Within the Configure Process the operator establishes Associations that define how pieces of Utilization Equipment and Wireless Control Devices are related to one another. Business Rules must be established for each piece of Utilization Equipment and for each Wireless Control Device that are to be related before an Association can be established.

As illustrated in FIG. 5, to establish an Association within the Configure Process, the operator clicks on the Configure button 16 on the Tool Bar 17 that appears on the design and authorization system for wireless control home page on the Computer Display Screen.

As illustrated in FIG. 6 this action causes a new window 18 to appear; the Building Floor Plan Drawing 19 to be retrieved from the system's database and displayed on the screen; all Virtual Control Devices 200 to appear on the screen; and a message to display in the Command Line 20 at the bottom of the screen prompting the operator to select either Establish/Edit a Business Rule or Establish/Edit an Association from the tool bar above.

As illustrated in FIG. 16 the operator clicks on the Establish/Edit an Association button 82. This action causes a message 83 to display in the Command Line at the bottom of the screen prompting the operator to select either the piece of Utilization Equipment or select the Wireless Control Device that the Association is to be established for.

The operator selects the pieces of Utilization Equipment and Wireless Control Devices to be associated by clicking on the icons that represent each of them, one at a time, from the Building Floor Plan Drawing. As further illustrated in FIG. 16 clicking on an icon 84 causes it to become highlighted 85. Icons can be selected individually or alternatively the operator can select multiple pieces of Utilization Equipment and

Wireless Control Devices to be Associated in one activity by holding down the left mouse button and moving the pointer over the pieces of Utilization Equipment and Wireless Control Devices desired. As the operator performs this action the area selected becomes framed 86 and all of the icons within the selection area become highlighted 87. The operator can include additional pieces of Utilization Equipment and Wireless

Control Devices in the Association activity by holding down the shift key on the computer keyboard and clicking of the individual icon(s) to be included. This action causes the selected icon(s) to also become highlighted and included in the immediate Association activity.

Icons that are highlighted can be excluded from the immediate Association activity underway by holding down the shift key on the computer keyboard and clicking of the individual icon(s) to be excluded. This action will cause that icon to no longer be highlighted and the represented piece of Utilization Equipment or Wireless Control Device will not be included in the Association activity underway. All other selected icons remain highlighted.

After the first piece of Utilization Equipment 84 and the first Wireless Control Device 88 icons have been selected a new window 89 to open asking the operator to confirm that the Association is to be established. This new window 89 remains open until all desired icons to be included in this Association have been selected. When the operator clicks the Yes button 90 the Association is established, the information is saved in the system's database, the pieces of Utilization Equipment and Wireless Control Devices are now related and they will operate in accordance with the specific Business Rules that were established for each individual piece of Utilization Equipment and Wireless Control Device; the new window 89 disappears from view; and the system reverts back to the Building Floor Plan Drawing on the Computer Display Screen. When the operator clicks the No button 91 the new window 89 will disappear from view, the selected icon(s) that the Association was to be established with will no longer be highlighted and the system will revert back to the Building Floor Plan Drawing on the Computer Display Screen.

The design and authorization system for wireless control Authorization Procedure establishes the system's software logic and Building Floor Plan Drawings with the physical presence and location of Wireless Control Modules and Wireless Control Devices. After Business Rules and Associations have been established for all Wireless Control Modules and Wireless Control Devices the design and authorization system for wireless control is installed within the Controlled Environment and integrated with the Energy Management System.

All Wireless Control Modules and Wireless Control Devices are physically installed in the building structure in their locations are determined within the Design Process. The Operator turns Energy Management System ‘ON’ and uses the design and authorization system for wireless control Authorization Procedure to establish communication with all installed Wireless Control Devices and Wireless Control Modules via communication with each RFID tag.

The Wireless Control Modules and Wireless Control Devices communicate their presence via their RFID tag and the design and authorization system for wireless control Authorization Procedure assesses the physical location of each Wireless Control Module and Wireless Control Device within the building structure and authenticates their locations on the Building Floor Plan Drawings stored in the system's database.

Once the Authorization Procedure has been complete, then the design and authorization system for wireless control is ready for daily operation.

After initial installation of the system, from time to time, reconfiguration of operational relationships is required. Reconfiguring operational relationships between one or more wireless Control Modules and one or more wireless Control Devices within a Controlled Environment is performed through the Editing Procedure of the design and authorization system for wireless control. It is through the Editing Procedure that the operator makes changes, additions and deletions to already established Business Rules and Associations. Reconfiguration takes place either through Reconfiguring by editing a Business Rule or through Reconfiguring by editing an Association.

Once a Business Rule has been established, the operator Edits a Business Rule for a piece of Utilization Equipment or for a Wireless Control Device by clicking on the Configure button 16 on the Tool Bar 17 as previously illustrated in FIG. 5 that appears on the design and authorization system for wireless control home page on the Computer Display Screen.

As illustrated in FIG. 6 this action causes a new window 18 to appear; the Building Floor Plan Drawing 19 to be retrieved from the system's database and displayed on the screen; all virtual Control Devices 200 to appear on the screen; and a message to display in the Command Line 20 at the bottom of the screen prompting the operator to select either Establish/Edit a Business Rule or Establish/Edit an Association from the tool bar above.

As illustrated in FIG. 7 the operator clicks on the Establish/Edit a Business Rule button 21. This action causes a message 22 to display in the Command Line at the bottom of the screen prompting the operator to select either the piece of Utilization Equipment or select the Wireless Control Device that the Business Rule is to be established for.

Every piece of Utilization Equipment has a Wireless Control Module linked to it, thus on the Building Floor Plan Drawing each Wireless Control Modules is represented by the icon of the piece of Utilization Equipment to which it is linked. From the Building Floor Plan Drawing the operator makes the selection by clicking on the icon that represents the desired piece of Utilization Equipment to be reconfigured. As illustrated in FIG. 17 this will cause the piece of Utilization Equipment icon selected 92 will become highlighted 93 and the Parameter Setting Window 94 containing the Business Rules that have previously been established for the selected piece of Utilization Equipment (as an example in this illustration: a Light Fixture ID# 0132592) to appear on the Computer Display Screen.

As further illustrated in FIG. 17 the operator deletes Business Rules in part or in whole by holding down the left mouse key and highlighting the text 95 to be delete from the Parameter Setting Window and pressing the delete key on the computer keyboard. This action causes the highlighted text 95 to disappear from view.

At any time the operator uses the Reverse button 202 to cancel the most recent deletion and revert back to the immediate prior state.

To add new Business Rules the operator selects if the new parameter settings are to be applied to the Normal Operation 96 of the piece of Utilization Equipment or if the parameters to be edited are to be applied as an Exception 97 to the Normal Operation. The operator selects and inputs all of the new parameters as desired. As the operator inputs and selects each new parameter the results of the inputs and selections appear in the Parameter Setting Window 94 providing the operator with a visual description of the Business Rule in its edited form.

Again, at any time the operator can use the Reverse button 202 to cancel the most recent deletion and revert back to the immediate prior state.

The operator saves the edited Business Rule in the system's database by clicking on the Save button 98 and the Parameter Setting Window closes and disappears from view; the selected icon is no longer highlighted and the display returns to the Building Floor Plan Drawing. The operator cancels the edited parameter settings by clicking on the Cancel button 99 and all of the edited parameters will revert back to those currently stored in the system's database; the Parameter Setting Window closes and disappears from view; the selected icon is no longer highlighted and the display returns to the Building Floor Plan Drawing.

On the Building Floor Plan Drawing Wireless Control Devices are represented by the icons that represent their function. From the Building Floor Plan Drawing the operator makes the selection by clicking on the icon that represents the desired Wireless Control Device to be reconfigured. As illustrated in FIG. 17a this will cause the Wireless Control Device icon selected 203 will become highlighted 204 and the Parameter Setting Window 205 containing the Business Rules 206 that have previously been established for the selected Wireless Control Device (as an example in this illustration: a Light Harvester ID# B7895) to appear on the Computer Display Screen.

As further illustrated in FIG. 17a the operator deletes Business Rules in part or in whole by holding down the left mouse key and highlighting the text 207 to be delete from the Parameter Setting Window and pressing the delete key on the computer keyboard. This action causes the highlighted text 207 to disappear from view.

At any time the operator uses the Reverse button 208 to cancel the most recent deletion and revert back to the immediate prior state.

To add new Business Rules the operator selects and inputs all of the new parameters as desired. As the operator inputs and selects each new parameter the results of the inputs and selections appear in the Parameter Setting Window 206 providing the operator with a visual description of the Business Rule in its edited form.

The operator saves the edited Business Rule in the system's database by clicking on the Save button 209 and the Parameter Setting Window closes and disappears from view; the selected icon is no longer highlighted and the display returns to the Building Floor Plan Drawing. The operator cancels the edited parameter settings by clicking on the Cancel button 210 and all of the edited parameters will revert back to those currently stored in the system's database; the Parameter Setting Window closes and disappears from view; the selected icon is no longer highlighted and the display returns to the Building Floor Plan Drawing.

From the Building Floor Plan Drawing, once an Association has been established the operator can Edit the Association by first clicking on a piece of Utilization Equipment or by either first clicking on a Wireless Control Device. The operator initiates the Edit Procedure by clicking on the Configure button 16 on the Tool Bar 17 as previously illustrated in FIG. 5 that appears on the design and authorization system for wireless control home page on the Computer Display Screen.

As illustrated in FIG. 6 this action causes a new window 18 to appear; the Building Floor Plan Drawing 19 to be retrieved from the system's database and displayed on the screen; all virtual Control Devices 200 to appear on the screen; and a message to display in the Command Line 20 at the bottom of the screen prompting the operator to select either Establish/Edit a Business Rule or Establish/Edit an Association from the tool bar above.

As illustrated in FIG. 18 the operator clicks on the Establish/Edit an Association button 100. This action causes a message 102 to display in the Command Line at the bottom of the screen prompting the operator to select the piece of Utilization Equipment or Wireless Control Device that the Association is to be edited for.

As illustrated in FIG. 19 the operator clicks on the desired icon that represents a Wireless Control Device on the Building Floor Plan Drawing to identify the individual pieces of Utilization Equipment which are currently Associated with the specific Wireless Control Device selected. Clicking on a Wireless Control Device icon causes several things to occur: the selected Wireless Control Device icon 103 becomes highlighted 104 on the screen; and the Building Floor Plan Drawing window pans-back 105 as needed to reveal all pieces of Utilization Equipment that are currently Associated with the selected Wireless Control Device. The icons for the associated piece(s) of Utilization Equipment 106 also become highlighted 107 on the screen.

As illustrated in FIG. 20 the operator adds unassociated pieces of Utilization Equipment to the existing Association by clicking on one or more icons for the piece(s) of Utilization Equipment to be added. This causes the selected icons 108 to also become highlighted 109.

Icons can be selected individually or alternatively as illustrated in FIG. 21 the operator can select multiple pieces of Utilization Equipment to be Associated in one activity by holding down the left mouse button and moving the pointer over the pieces of Utilization Equipment desired. As the operator performs this action the area selected becomes framed 110 and all of the icons within the selection area become highlighted 111. The operator can include additional pieces of Utilization Equipment in the Association activity by holding down the shift key on the computer keyboard and clicking of the individual icon(s) to be included. This action causes the selected icon(s) to also become highlighted and included in the immediate Association activity.

Icons that are highlighted on the screen can be deleted from the Association by holding down the shift key on the computer keyboard and clicking of the individual icon(s) to be excluded. This action will cause that icon(s) to no longer be highlighted and the represented piece(s) of Utilization Equipment will deleted from the Association activity. All other selected icons remain highlighted. At any time the operator uses the Reverse button 211 to cancel the most recent deletion and revert back to the immediate prior state.

As further illustrated in FIG. 21 after the first piece of Utilization Equipment to be added has been selected a new window 112 opens asking the operator to confirm that the Association is to be established. This new window 112 remains open until all desired icons to be included in this Association have been selected. When the operator clicks the Yes button 113 the Association is established; the information is saved in the system's database; the pieces of Utilization Equipment and the Wireless Control Device are now related and they will operate in accordance with the specific Business Rules that were established for each individual piece of Utilization Equipment and Wireless Control Device; the new window 112 disappears from view; the selected icon(s) that the Association was edited for are no longer highlighted and the system reverts back to the Building Floor Plan Drawing on the Computer Display Screen. When the operator clicks the No button 114 the new window 112 disappears from view: the selected icon(s) that the Association was to be established with will no longer be highlighted and the system will revert back to the Building Floor Plan Drawing on the Computer Display Screen.

To reconfigure an established Association by adding one or more Wireless or Virtual Control Devices to the Association with the selected piece of Utilization Equipment, as illustrated in FIG. 22, the operator clicks on any icon that represents a piece of Utilization Equipment on the Building Floor Plan Drawing to identify all physical Wireless Control Devices and Virtual Control Devices that are currently Associated with the specific piece of Utilization Equipment selected. Clicking on a piece of Utilization Equipment icon causes several things to occur: the selected piece of Utilization Equipment icon 115 becomes highlighted 116 on the screen: the Building Floor Plan Drawing pans-back 117 as needed to reveal all physical Wireless Control Devices 118 and Virtual Control Devices 119 that are Associated with that specific piece of Utilization Equipment; all Associated physical Wireless Control Devices and Virtual Control Devices become highlighted 120 on the screen; and a new window 121 opens which shows a Horizontal Diagram 122 of icons for all Wireless and Virtual Control Devices with an indication of their configured relationships to the selected piece of Utilization Equipment.

As further illustrated in FIG. 22 the Horizontal Diagram 122 is a pictorial rendering of all physical Wireless Control Devices and Virtual Control Devices Associated with a specific piece of Utilization Equipment. The Horizontal Diagram is also a rendering of the Control Strings 123 which show how these control devices are related to one another and related to a specific piece of Utilization Equipment. Control Strings are included within the Business Rules established for each control device.

How a selected control device may be added and configured into an Association is determined by the Business Rules that have been previously established for that specific Wireless Control Device or Virtual Control Device. These Business Rules determine wether or not a control device is restricted and can be added to an existing Association in only one specific way or wether the user has the unrestricted capability to decide how the control device is to be added.

As illustrated in FIG. 23 to add a Wireless Control Device or Virtual Control Device to an established Association the operator clicks on the Add button 124 within the Horizontal Diagram and then clicks on the icon 125 which represents the control device to be added to the Association. This activity causes the selected control device icon to become highlighted 126. The operator then proceeds to “drag-and-drop” the selected control device icon from the Building Floor Plan Drawing into the Horizontal Diagram by moving the pointer to the selected icon, clicking on the icon and holding down the left button on the system's mouse and “dragging” the icon into the Horizontal Diagram to the desired position 127 on the desired string and then releasing the mouse button. This action causes the selected control device icon to remain highlighted on the Building Floor Plan Drawing; the Horizontal Diagram to appear updated to include the added Wireless Control Device; and a new window 128 opens prompting the operator to confirm that the reconfigured Association is to be saved.

The operator continues to add other Wireless and Virtual Control Devices to the established Association until all desired control devices have been added. The operator uses the Reverse button 129 to cancel the most recent addition and revert back to the immediate prior state. The operator clicks on the Yes button 130 to save the edited Association in the system's database and the Horizontal Diagram disappears from view. The operator clicks on the No button 131 to cancel the editing activity, the edited additions will not he saved and the Horizontal Diagram disappears from view.

As illustrated in FIG. 24 the operator will be prompted in the Command Line 132 when an attempt is made to add a Wireless or Virtual Control Device in a area within the Horizontal Diagram that is restricted and the operator will not be allowed to “drop” a control device icon into the restricted location. The activity will be declined.

As illustrated hi FIG. 25 to delete a Wireless or Virtual Control Device from an established Association the operator clicks on the Delete button 133 within the Horizontal Diagram and then clicks on the icon(s) 134 from the Building Floor Plan Drawing that represents the Wireless Control Device to be deleted from the Association. This activity causes the selected Wireless Control Device icon to no longer be highlighted on the Building Floor Plan Drawing; the Wireless Control Device is removed 135 from the Horizontal Diagram pictorial; and a new window 136 opens prompting the operator to confirm that the reconfigured Association is to be saved.

The operator continues to delete other control devices from the established Association until all desired Wireless Control Devices and Virtual Control Devices have been deleted. The operator uses the Reverse button 137 to cancel the most recent deletion and revert back to the immediate prior state. The operator clicks on the Yes button 138 to save the edited Association in the system's database and the Horizontal Diagram disappears from view. The operator clicks on the No button 139 to cancel the editing activity, the edited deletions will not be saved and the Horizontal Diagram disappears from view.

As illustrated in FIG. 26 the operator will be prompted in the Command Line 140 when an attempt is made to delete a Control Device that is restricted and the activity will be declined.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for designing, configuring, and reconfiguring operational relationships between one or more wireless control modules within a controlled environment and one or more wireless control devices within a controlled environment, wherein:
the wireless control modules are linked to pieces of utilization equipment or to an alternate electrical source;
the system comprises application software and a database which interfaces with computer-aided design (CAD) software and with energy management systems;
components within the controlled environment are linked externally to an electrical utility supplier, an alternate electrical source, and one or more pieces of utilization equipment,
the controlled environment comprises an energy management system connected to one or more RF transceivers;
the RF transceivers wirelessly communicate using radio frequency with one or more wireless control modules;
the wireless control modules and wireless control devices each contain a unique radio frequency identification (RFID);
the wireless control modules are each linked to individual pieces of utilization equipment and/or to an alternate electrical source;
the system comprises virtual control devices which recognize and measure conditions that are typically intangible and are logically associated through software parameters to individual pieces of utilization equipment via the wireless control modules to which the pieces of utilization equipment are linked;
the application software and a database is integrated with the computer-aided design (CAD) software system and with the an energy management system to provide the ability to create virtual control devices allowing an operator to create and modify building floor plan drawings including wireless control modules, wireless control devices, and virtual control devices.

2. The system for designing, configuring, and reconfiguring operational relationships of claim 1 wherein the wireless control module functions include:
sending information and/or receiving instructions in the form of commands sent from the energy management system via the RF transceiver;
executing those commands; and
collecting data that is then sent back to the energy management system via the RF transceiver.

3. The system for designing, configuring, and reconfiguring operational relationships of claim 1 wherein the wireless control device functions include:
recognizing changes in the physical environment;
measuring values; and
collecting data.

4. The system for designing, configuring, and reconfiguring operational relationships of claim 3 wherein:
the wireless control devices wirelessly communicate information back to the energy management system via radio frequency to the RF transceiver; and
the information and data received from the wireless control modules and the wireless control devices are deposited and maintained within the energy management system's database.

5. The system for designing, configuring, and reconfiguring operational relationships of claim 1 wherein functions of a remote control device functions include communicating with the energy management system via the internet allowing a user to operate and maintain the energy management system from a remote location.

6. The system for designing, configuring, and reconfiguring operational relationships of claim 1 wherein the application software is used within the controlled environment when integrated with the energy management system and external to the controlled environment when integrated with a computer-aided design (CAD) software system.

7. The system for designing, configuring, and reconfiguring operational relationships of claim 1 wherein the wireless control module is a device that monitors and controls the operation of an individual piece of utilization equipment and/or the alternate electrical source.

8. The system for designing, configuring, and reconfiguring operational relationships of claim 7 wherein every individual piece of utilization equipment and the alternate electrical source is linked to a separate wireless control module.

9. The system for designing, configuring, and reconfiguring operational relationships of claim 7 wherein each wireless control module:
maintains a unique electronic radio frequency identity (RFID);
wirelessly communicates with the energy management system;
accepts commands issued from the energy management system as transmitted from the RF transceiver;
executes commands; and
wirelessly communicates a variety of data and information back to the energy management system via the RF transceiver.

10. The system for designing, configuring, and reconfiguring operational relationships of claim 7 wherein the wireless control module:
uses radio frequency to establish wireless communication with the RF transceiver;
measures electrical current and voltage;
recognizes the piece of utilization equipment's present operating state;
measures state-of-health;
receives information requests and commands from the energy management system; executes commands that it receives; and
transmits information and state-of-health conditions and other data to the RF transceiver.

11. The system for designing, configuring, and reconfiguring operational relationships of claim 1 wherein the wireless control device functions as a sensor to:
recognize and measure conditions within the general environment;
maintain a unique electronic radio frequency identity (RFID); and
use radio frequency to wirelessly communicate this information to the RF transceiver.

12. The system for designing, configuring, and reconfiguring operational relationships of claim 11 wherein the wireless control devices are logically related through software parameters to individual pieces of utilization equipment via the wireless control modules to which the pieces of utilization equipment are linked.

13. The system for designing, configuring, and reconfiguring operational relationships of claim 1 wherein the energy management system provides:
real-time and historical visibility to electrical usage;
performance data of each piece of utilization equipment; and
management and control over the source of electrical supply and the amount of electricity consumed by utilization equipment.

14. The system for designing, configuring, and reconfiguring operational relationships of claim 13 wherein the energy management system comprises a programmable computer with a user interface, a computer display screen, a mouse, a keyboard, a database, and I/O ports suitable for communicating with components of the controlled environment.

15. The system for designing, configuring, and reconfiguring operational relationships of claim 1 wherein:
the RF transceivers receive instructions from the energy management system and wirelessly communicate commands to one or more wireless control modules using radio frequency communication; and
the RF transceivers wirelessly communicate using radio frequency with one or more wireless control devices and wireless control modules to receive information and to pass that information on to the energy management system.

16. The system for designing, configuring, and reconfiguring operational relationships of claim 1 wherein a remote control device provides authorized users and system operators access from a remote location to visibility functions and to management & control functions of the energy management system.

17. The system for designing, configuring, and reconfiguring operational relationships of claim 16 wherein the remote control device is a personal computer or a small hand-held type device that communicates via the internet with the energy management system.

18. The system for designing, configuring, and reconfiguring operational relationships of claim 17 wherein authorization levels established within the energy management system determine which functions the operator using the remote control device may perform.
